(19) United States
(12) Patent Application Publication
(10) Pub. No.: US 2011/0181020 A1
(43) Pub. Date: Jul. 28, 2011

(54) SYSTEM FOR DETERMINING THE POSITION OF A ROAD TRACTOR AND A SEMI-TRAILER IN RELATION TO EACH OTHER DURING A COUPLING OPERATION

(76) Inventor: Martinus Theodorus Van de Wetering, Lithoijen (NL)

(21) Appl. No.: 13/059,038

(22) PCT Filed: Jul. 23, 2009
(86) PCT No.: PCT/NL2009/000153

§ 371 Date: Apr. 14, 2011

(30) Foreign Application Priority Data
Aug. 13, 2008 (NL) 2001887

(51) Int. Cl. B62D 53/12; B62D 53/06

(52) U.S. Cl. 280/423.1

(57) ABSTRACT

A road tractor semi-trailer combination is equipped with a system for determining the position of a road tractor relative to a semi-trailer. A king pin is fitted to the bottom of the semi-trailer and a unit is fitted to the bottom of the fifth wheel coupling present on the road tractor. The bottom of the king pin has a recess into which a pivot forming part of the unit can be inserted. The pivot has the shape of a screwdriver and the recess has a shape congruent with the pivot.

### BACKGROUND OF THE INVENTION

1. Field of the Invention

The invention relates to a system for determining the position of a road tractor and a semi-trailer in relation to each other during the coupling of the road tractor to the semi-trailer.

2. State of the Art

Many systems are known that determine the position of a road tractor relative to a semi-trailer. However, these systems do not determine this position until the road tractor has been coupled to the semi-trailer. One of the systems of this type is known from US-A-2004/0017285. This known system has a concentric gear fixedly attached to the king pin and also has a further gear pivotably connected to the road tractor which is in engagement with the gear attached to the king pin. While the position of the road tractor relative to the semi-trailer is being changed, the road tractor turns around the king pin and the further gear turns around its axis. The turning of this further gear is measured and the position of the road tractor relative to the semi-trailer is determined based on this measurement.

### SUMMARY OF THE INVENTION

It is an object of the invention to provide a compact and robust system of the type defined in the opening paragraph with which the position of the road tractor relative to the semi-trailer can be determined not only after the road tractor has been coupled to the semi-trailer but also during the coupling operation. For this purpose the system according to the invention is characterised in that a recess is provided at the bottom of the king pin or a pivot is present at the bottom of the king pin and the unit comprises a pivot fitting into the recess, or a component part provided with a recess into which the pivot fits, which pivot or component part can be turned and displaced in axial direction relative to the rest of the unit, and which recess and pivot have such a shape that the pivot snugly fits into the recess in only one or two states, where the pivot when inserted into the recess or the component part when stuck over the pivot of its own accord turns to one of the states in which the pivot completely fits into the recess. So the pivot is self-seeking in the recess. By measuring the angle of twist of the pivot and the recess relative to each other the position of the road tractor relative to the semi-trailer can be determined.

An embodiment in which the pivot and the recess are suitably formed to be engaged with each other is characterised in that the pivot has a screwdriver-shaped end and the recess has a shape congruent with the pivot. The edges of the pivot are then preferably rounded off.

A further embodiment of the system according to the invention is characterised in that the unit comprises displacement means for displacing the pivot or the component part in axial direction. After the king pin has been received in the central opening of the fifth wheel coupling under which the unit is present, the pivot or the component part is moved upwards while the pivot or the component part is inserted into the recess present in the king pin or stuck over the pivot present on the king pin.

The unit preferably comprises a twist angle meter for measuring the angle of twist of the pivot forming part of the unit or of the component part forming part of the unit.

The pivot or component part is self-seeking in the recess or over the pivot respectively if the two portions (pivot on the one hand and recessed component part or king pin on the other) are turned in relation to each other by no more than 35 degrees relative to the position in which the two parts completely fit into each other. If the road tractor is coupled to the semi-trailer at an angle that is in excess of 35 degrees, for example at right angles, the parts cannot be completely stuck into each other.

An embodiment of the system according to the invention that solves this problem is characterised in that the unit further includes turning means for turning the pivot or the component part at an angle. The driver can optionally turn the pivot or the component part at a 35 to 90 degree angle, so that the parts end up in such a position relative to each other that they are self-seeking. This pre-effected angle of twist is automatically added up by the twist angle meter to the angle of twist to be measured afterwards.

The invention also relates to a road tractor semi-trailer combination of which the road tractor comprises a fifth wheel coupling and the semi-trailer is provided with a king pin which can be coupled to the fifth wheel coupling which is equipped with the system according to the invention.

An embodiment of the road tractor semi-trailer combination according to the invention is characterised in that the fifth wheel coupling has a central opening and a recess widening to the outer periphery from the central opening onwards for receiving the king pin during the coupling operation, which unit is fitted to the bottom of the fifth wheel coupling, so that the pivot or the component part is present under the central opening in the fifth wheel coupling. In consequence, the unit is always positioned right under the king pin so that the pivot or the component part of the unit can always be received in the recess present in the king pin or can be stuck over the pivot present on the king pin.

A further embodiment of the road tractor semi-trailer combination according to the invention is characterised in that the road tractor is provided with a drive unit which is coupled to the unit on the fifth wheel coupling, which drive unit does not start operating until the pivot has been fully received in the recess. The drive unit can drive for example the following parts:
self-steering axles of the semi-trailer,
cornering mirrors on the road tractor,
cornering reversing lamps on the road tractor,
automatic coupling system for coupling electrical lines and air brake lines between the road tractor and the semi-trailer.
   In order to avoid accidents, all these components must not be driven until the pivot has been fully lodged in the recess and thus the correct angle of twist has been measured.

### BRIEF DESCRIPTION OF THE DRAWINGS

The invention will now be described in more detail below based on an example of embodiment of the road tractor semi-trailer combination and the system according to the invention while reference is made to the appended drawing figures, in which:

FIG. 1 shows a part of the road tractor semi-trailer combination comprising the system according to the invention;

FIG. 2 shows a sectional view of the road tractor semi-trailer combination along the line II-II in FIG. 1;

FIG. 3 shows the king pin of the system; and

FIG. 4 shows the unit of the system.

### DETAILED DESCRIPTION

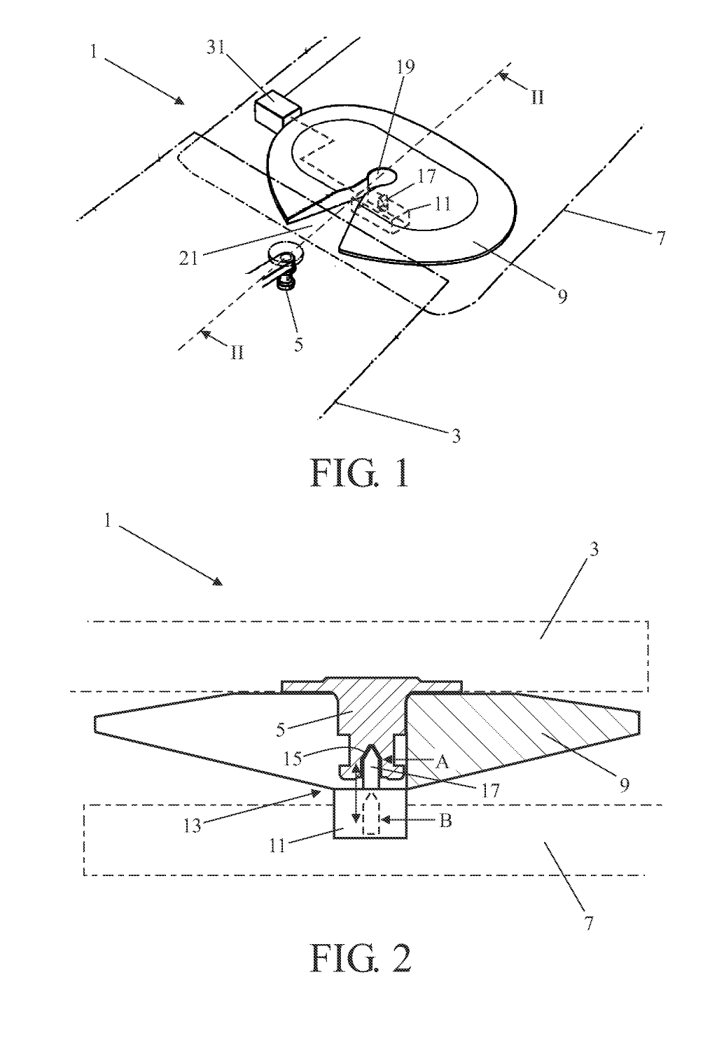

FIGS. 1 and 2 show a part of the road tractor semi-trailer combination 1 according to the invention in a perspective view briefly before the road tractor is coupled to the semi-trailer, and a sectional view respectively along the line II-II after the road tractor has been coupled to the semi-trailer. A king pin 5 is fitted to the bottom of the semi-trailer 3 and a unit 11 is fitted to the bottom of the fifth wheel coupling 9 located on the road tractor 7. This king pin and unit form part of a system 13 for measuring the position of the semi-trailer relative to the road tractor.

The bottom of the king pin 5 has a recess 15 (see FIG. 2) into which a pivot 17 forming part of the unit 11 can be inserted. This pivot 17 is movable in axial direction between a position A in which the pivot is fully received in the recess (this is meant to be understood as the position in which the end of the pivot touches the bottom of the recess) and a position B in which the pivot has fully left the recess.

The unit 11 is located under the fifth wheel coupling in the place of a central opening 19 in the fifth wheel coupling 9 (see FIG. 1). From this central opening 19 extends a widening recess 21 for catching the king pin 5 and guiding it to the central opening 19 during the coupling operation of the road tractor 7 to the semi-trailer 3.

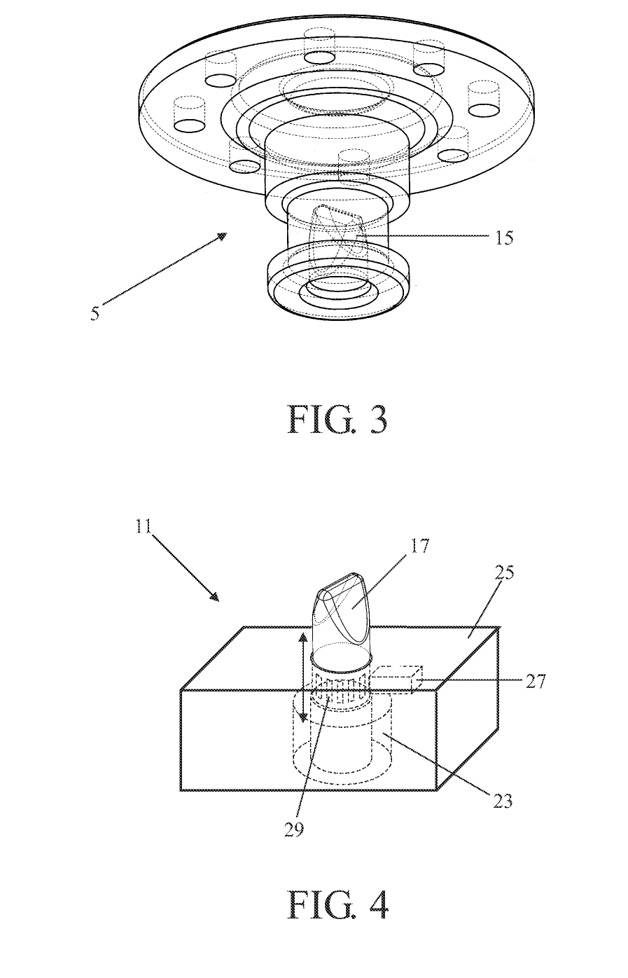

The pivot 17 has the shape of a screw-driver (see FIG. 4) and the recess 15 in the king pin 5 has a shape congruent therewith (see FIG. 3). The pivot can be fully received by the recess 15 in only one position, the coupling position (and a further position turned through 180 degrees relative to this one position, which, however, cannot occur in practice). If the pivot 17 is inserted into the recess 15 in a position that is twisted relative to this coupling position, the pivot will move towards the coupling position. The shape of the pivot and the recess is such that the pivot autonomously seeks its place in the recess. For this purpose the edges of the pivot 17 are rounded off The pivot autonomously seeks its place until a position is reached that is turned through 35 degrees relative to the coupling state.

If the semi-trailer stands right behind the road tractor, the pivot is in the coupling state with respect to the recess, so that the pivot will not be twisted when it is inserted into the recess. If the semi-trailer does not stand right behind the road tractor, but the road tractor stands at an angle relative to the semi-trailer, the pivot will be twisted when inserted into the recess until the pivot is fully received in the recess. The size of this angle of twist is the angle at which the road tractor stands relative to the semi-trailer.

For inserting the pivot 17 into the recess 15, the unit 11 comprises displacement means 23 (see FIG. 4), for example a solenoid which is accommodated in the housing 25 of the unit and the unit 11 further includes turning means which are integrated with the solenoid to turn the pivot 17 prior to the coupling operation when there is a large angle between the road tractor and the semi-trailer and the pivot no longer autonomously seeks its place. The unit 11 further includes a twist angle meter 27 which measures the angle by which the pivot 17 is twisted. The twist angle meter 27 is for example an optical sensor which counts the number of times the marks 29 on the pivot 17 are passed.

The system further includes a drive unit 31 (see FIG. 1) which is coupled to the twist angle meter of the unit 11 and which drives for example cornering mirrors or reversing lights on the road tractor in dependence on the detected angle of twist of the pivot.

Albeit the invention has been described in the foregoing based on the drawings, it should be observed that the invention is not by any manner or means restricted to the embodiment shown in the drawings. The invention also extends to all embodiments deviating from the embodiment shown in the drawings within the spirit and scope defined by the claims.

1. A system for determining the position of a road tractor and a semi-trailer in relation to each other during the coupling of the road tractor to the semi-trailer, comprising a king pin that can be mounted at the bottom of the semi-trailer, as well as a unit that can be mounted on a fifth wheel coupling of the road tractor, characterised in that a recess is provided at the bottom of the king pin or a pivot is present at the bottom of the king pin and the unit on the fifth wheel coupling comprises a pivot fitting into the recess, or a component part having a recess into which the pivot fits, which pivot or component part can be turned and displaced in axial direction relative to the rest of the unit, and which recess and pivot have such a shape that the pivot snugly fits into the recess in only one or two states, where the pivot when inserted into the recess or the component part when stuck over the pivot by itself turns to one of the states in which the pivot completely fits into the recess.

2. The system as claimed in claim 1, characterised in that the pivot has a screwdriver-shaped end and the recess has a shape congruent with the pivot.

3. The system as claimed in claim 2, characterised in that the edges of the pivot are rounded off

4. The system as claimed in claim 1, characterised in that the unit on the fifth wheel coupling comprises displacement means for displacing the pivot or the component part in axial direction.

5. The system as claimed in claim 1, characterised in that the unit on the fifth wheel coupling comprises a twist angle meter for measuring the angle of twist of the pivot or the component part.

6. The system as claimed in claim 1, characterised in that the unit on the fifth wheel coupling further includes turning means for turning the pivot or the component part at an angle.

7. A road tractor semi-trailer combination comprising:
a road tractor comprising a fifth wheel coupling;
a semi-trailer comprising a king pin which can be coupled to the fifth wheel coupling;
a system for determining the position of the road tractor and the semi-trailer in relation to each other during the coupling of the road tractor to the semi-trailer, the system comprising:
a king pin adapted to be mounted at the bottom of the semi-trailer; and
a unit adapted to be mounted on a fifth wheel coupling of the road tractor, the fifth wheel coupling having a recess or a pivot at a bottom of the king pin, the unit on the fifth wheel coupling comprising: a pivot fitting into the recess, or a component part having a recess into which the pivot fits, which pivot or component part can be turned and displaced in axial direction relative to the rest of the unit, and which recess and pivot have such a shape that the pivot snugly fits into the recess in only one or two states, where the pivot when inserted into the recess or the component part when stuck over the pivot by itself turns to one of the states in which the pivot completely fits into the recess.

8. The combination as claimed in claim 7, characterised in that the pivot has a screwdriver-shaped end and the recess has a shape congruent with the pivot.

9. The combination as claimed in claim 8, characterised in that the edges of the pivot are rounded off

10. The combination as claimed in claim 7, characterised in that the unit comprises displacement means for axially displacing the pivot or the component part.

11. The combination as claimed in claim 7, characterised in that the unit comprises a twist angle meter for measuring the angle of twist of the pivot or the component part.

12. The combination as claimed in claims 7, characterised in that the unit further includes turning means for turning the pivot or component part at angle.

13. The combination as claimed in claim 7, characterised in that the fifth wheel coupling is provided with a central opening and a recess widening to the outer periphery from the central opening onwards for receiving the king pin during the coupling operation, which unit is fitted to the bottom of the fifth wheel coupling so that the pivot or the component part is present under the central opening in the fifth wheel coupling.

14. The combination as claimed in claim 7, characterised in that the road tractor is provided with a drive unit which is coupled to the unit on the fifth wheel coupling, which drive unit does not start operating until the pivot has been fully received in the recess.

15. A system for determining the position of a road tractor and a semi-trailer in relation to each other during the coupling of the road tractor to the semi-trailer, the system comprising:
a king pin adapted to be mounted at the bottom of the semi-trailer; and
a unit adapted to be mounted on a fifth wheel coupling of the road tractor, the fifth wheel coupling having a recess or a pivot at a bottom of the king pin, the unit on the fifth wheel coupling comprising: a pivot fitting into the recess, or a component part having a recess into which the pivot fits, which pivot or component part can be turned and displaced in axial direction relative to the rest of the unit, and which recess and pivot have such a shape that the pivot snugly fits into the recess in only one or two states, where the pivot when inserted into the recess or the component part when stuck over the pivot by itself turns to one of the states in which the pivot completely fits into the recess.
